(19) United States
(12) Patent Application Publication
(10) Pub. No.: US 2026/0350673 A1
(43) Pub. Date: Nov. 5, 2026

(54) Government Offer Matching and Contract Response Logic Within Platform-Licensed Execution System

(71) Applicant: ADRIAN FARIAS JARAMILLO, JURUPA VALLEY, CA (US)

(72) Inventor: ADRIAN FARIAS JARAMILLO, JURUPA VALLEY, CA (US)

(21) Appl. No.: 19/336,105

(22) Filed: Sep. 22, 2025

Related U.S. Application Data
(63) Continuation of application No. 19/197,894, filed on May 2, 2025.
(60) Provisional application No. 63/786,937, filed on Apr. 10, 2025.
(60) Provisional application No. 63/787,944, filed on Apr. 13, 2025.
(60) Provisional application No. 63/788,834, filed on Apr. 15, 2025.
(60) Provisional application No. 63/791,534, filed on Apr. 20, 2025.
(60) Provisional application No. 63/792,918, filed on Apr. 23, 2025.

(51) Int. Cl. G06Q 30/0601; G06Q 10/083

(52) U.S. Cl. CPC G06Q 30/0611; G06Q 10/083

(57) ABSTRACT

A sealed execution system for public agency contracts. Contract requests are posted by government entities, matched to licensed, jurisdiction-cleared vendors, and gated through escrow and trust verification. Unauthorized vendors are blocked. The system ensures all contract execution occurs within a platform-licensed, audit-compliant environment.

### CROSS-REFERENCE TO RELATED APPLICATIONS

This application is a continuation of U.S. Utility patent application Ser. No. 19/197,894, filed May 2, 2025, which claims the benefit of the following U.S. Provisional Patent Applications, each of which is incorporated herein by reference in its entirety:
U.S. Provisional Application No. 63/786,937, filed Apr. 10, 2025, titled “System and Method for Buyer-Initiated Marketplace Transactions Across Multiple Industries”
U.S. Provisional Application No. 63/787,944, filed Apr. 13, 2025, titled “Sealed Toolset and Logic Framework for Buyer-Initiated Offer Systems”
U.S. Provisional Application No. 63/788,834, filed Apr. 15, 2025, titled “Toolset Protection for Modular Buyer-Initiated Offer Ecosystem”
U.S. Provisional Application No. 63/791,534, filed Apr. 20, 2025, titled “Modular Toolset Architecture for Multi-Sector Buyer-Initiated Commerce Infrastructure”
U.S. Provisional Application No. 63/792,918, filed Apr. 23, 2025, titled “Lockdown: Final Enforcement Tools for Global Buyer-Initiated Transaction Control”

### FIELD OF THE INVENTION

The present invention relates to commercial execution systems and, more specifically, to systems and methods for matching public agency offers with pre-verified vendors within a platform-bound sealed execution environment.

### BACKGROUND OF THE INVENTION

Traditional public contract bidding systems suffer from fragmentation, delays, and trust issues in vendor selection.

Current platforms fail to automate offer matching while enforcing vendor trust, jurisdictional license, and sealed contract conditions.

There exists a need for an automated, escrow-gated, trust-verified, government bidding execution system that restricts all activity to a licensed platform.

### SUMMARY OF THE INVENTION

This invention enables government agencies to upload contract requests into a sealed execution platform that auto-matches pre-approved, licensed vendors.

All vendor responses are escrow-held and cannot execute unless trust, license, and jurisdiction filters are passed.

The platform enforces digital fencing, allowing only jurisdiction-cleared vendors to respond to eligible contracts.

Contracts are fulfilled only through sealed execution rails with logging, audit, and metadata protection.

### DETAILED DESCRIPTION OF THE INVENTION

Government agencies can access a secure portal or interface linked to the sealed platform to post contract offers.

Vendor participants are verified against pre-cleared licensing databases and trust-score registries.

The platform uses metadata filters, location verification, and vendor identity scoring to match relevant contract opportunities.

Vendor responses are gated behind escrow until verified.

No contract can be executed or fulfilled outside the sealed system.

The system logs each response attempt with origin metadata and stores audit trails for regulatory compliance.

Vendors failing jurisdictional checks are blocked automatically.

The invention ensures public funds are used only with licensed, pre-vetted participants inside the sealed platform.

AI-based matching tools are used to surface top-tier vendors based on project type, trust score, and region.

What is claimed is:

1. A platform-based system for responding to government contract offers, comprising: an agency submission interface, a licensed vendor verification engine, a jurisdictional filter, and a sealed fulfillment rail.

2. The system of claim 1, wherein vendor responses are held in escrow until trust and license verification is confirmed.

3. A method comprising:
receiving a contract offer;
matching with licensed vendors;
gating execution through escrow;
and logging metadata for compliance.

4. The system of claim 1, wherein contracts are matched based on trust score, jurisdiction, and vendor category.

5. The method of claim 3, wherein the system denies execution if vendor metadata mismatches jurisdiction requirements.

6. A system for digitally fencing vendor eligibility by geographic, legal, and platform-verified boundaries.

7. The system of claim 1, further comprising an AI-based ranking engine to prioritize vendor matches.

8. A method comprising:
generating an escrow token;
associating it with vendor response;
and verifying license status before contract execution.

9. The system of claim 1, wherein all contract executions must be performed within the sealed platform.

10. A method for recording and monitoring each contract response with full audit metadata.

11. A vendor eligibility engine that filters based on agency-approved categories and license jurisdictions.

12. The system of claim 1, wherein failed responses are logged and blocked from future participation until resolved.

13. A compliance engine for comparing agency contract parameters with vendor platform status.

14. A system wherein vendors may not participate unless tethered to a platform-issued identity credential.

15. The method of claim 3, wherein escrow tokens expire if license re-verification fails during processing.

16. A sealed contract execution rail comprising: vendor ID mapping, license tiering, and jurisdictional filter stacking.

17. A government contract routing system tied to platform-native logic and trust-bound execution.

18. A method comprising:
receiving a public contract;
scoring vendors;
and authorizing execution only after full compliance.

19. The system of claim 1, wherein AI modules detect fraudulent submissions and prevent offer exposure.

20. A platform-native sealed execution system for government offers requiring escrow, metadata, trust score, and verified jurisdictional compliance.
